(19) United States
(12) Patent Application Publication
(10) Pub. No.: US 2015/0102185 A1
(43) Pub. Date: Apr. 16, 2015

(54) SUPPORT DEVICE FOR MONITOR OR DISPLAY

(71) Applicant: Oxti Corporation, Taipei (TW)

(72) Inventor: Chih Feng HO, Taipei (TW)

(73) Assignee: Oxti Corporation, Taipei (TW)

(21) Appl. No.: 14/051,536

(22) Filed: Oct. 11, 2013

(51) Int. Cl. A47B 97/00; F16M 11/16; F16M 11/22

(52) U.S. Cl. CPC A47B 97/00; F16M 11/22; F16M 11/16; A47B 2097/005
USPC 248/121

(57) ABSTRACT

A support device includes a stationary base having an upwardly extended protrusion and having a screw hole formed in the protrusion, a supporting arm having a compartment opened downwardly for engaging with the protrusion and having an orifice aligned with the screw hole of the protrusion for supporting a carrier, and a fastener engaged through the orifice the supporting arm and engaged with the screw hole of the protrusion for detachably securing the supporting arm on the stationary base and for preventing the supporting arm from being disengaged from the stationary base.

### BACKGROUND OF THE INVENTION

1. Field of the Invention

The present invention relates to a stable support device, and more particularly to a stable support device including a sliding structure or mechanism for coupling or attaching or mounting a carrier to a supporting stand and to support various objects, such as monitors, displays, keyboards, antenna members, or the like, and for providing a solid and stable supporting stand to solidly and stably support the carrier and the objects, such as the monitors, the displays, the keyboards, the antenna members, or the like.

2. Description of the Prior Art

Various kinds of typical carriers or support devices have been developed and comprise a supporting member or carrier member attached or mounted or supported on a supporting stand and for supporting various objects, such as monitors, displays, keyboards, antenna members, or the like.

For example, U.S. Pat. No. 3,345,024 to Maurice, U.S. Pat. No. 4,834,329 to Delapp, U.S. Pat. No. 4,880,270 to Cooper, U.S. Pat. No. 5,037,054 to McConnell, U.S. Pat. No. 5,123,621 to Gates, U.S. Pat. No. 5,553,820 to Karten et al., U.S. Pat. No. 5,713,549 to Shieh, U.S. Pat. No. 5,758,849 to Bui et al., U.S. Pat. No. 6,213,438 to Ostby et al., U.S. Pat. No. 6,766,994 to Serbinski et al., U.S. Pat. No. 6,796,537 to Lin, U.S. Pat. No. 6,863,252 to Bosson, U.S. Pat. No. 7,413,152 to Chen, U.S. Pat. No. 7,628,552 to Coppola, U.S. Pat. No. 7,644,897 to Shin, U.S. Pat. No. 7,722,003 to Ishizaki et al., and U.S. Pat. No. 7,784,747 to Gan et al. disclose several of the typical support devices or carrier devices each also comprising a support member or carrier member pivotally or rotatably attached or mounted or coupled to a supporting stand with one or more pivotal arms for supporting various objects, such as monitors, displays, keyboards, antenna members, or the like.

However, normally, the support members or carrier members and the pivotal arms and the supporting stands include a rather complicated structure or configuration and are pivotally or rotatably coupled together with pivot joints or axles and are adjustable to different angular positions by a frictional force between the members or elements, such that the frictional coupling portions between the members or elements will be easily worn out or damaged after use, and the supporting stands normally include a structure or configuration that may not be used to solidly and stably support the support members or carrier members.

The present invention has arisen to mitigate and/or obviate the afore-described disadvantages of the conventional support devices for monitors, displays, keyboards, antenna members, or other display apparatuses.

### SUMMARY OF THE INVENTION

The primary objective of the present invention is to provide a stable support device including a sliding structure or mechanism for coupling or attaching or mounting a carrier to a supporting stand and to support various objects, such as monitors, displays, keyboards, antenna members, or the like, and for providing a solid and stable supporting stand to solidly and stably support the carrier and the objects, such as the monitors, the displays, the keyboards, the antenna members, or the like.

In accordance with one aspect of the invention, there is provided a support device comprising a stationary base including an upwardly extended protrusion, and including a screw hole formed in the protrusion, a supporting arm including an upper portion and a bottom portion, and including a compartment formed in the bottom portion of the supporting arm and opened downwardly for engaging with the protrusion and for anchoring and supporting the supporting arm on the stationary base and for preventing the supporting arm from being oscillated or vibrated relative to the stationary base, and including an orifice formed in the supporting arm and communicating with the compartment of the supporting arm and aligned with the screw hole of the protrusion, a carrier to be supported on the supporting arm, and a fastener engaged through the orifice the supporting arm and engaged with the screw hole of the protrusion for securing the supporting arm on the stationary base and for preventing the supporting arm from being disengaged from the stationary base.

The protrusion of the stationary base includes a bore formed therein, and the supporting arm includes an anchoring pole extended into and located within the compartment of the supporting arm for engaging with the bore of the protrusion and for further positioning the supporting arm on the stationary base, and for further preventing the supporting arm from being oscillated or vibrated relative to the stationary base.

The stationary base includes a recess formed therein for receiving and engaging with the bottom portion of the supporting arm and for allowing the bottom portion of the supporting arm to be closely or snugly fitted or engaged in the recess of the stationary base.

The stationary base includes at least one anchoring hole formed therein, and the supporting arm includes at least one anchoring stud extended downwardly therefrom for engaging with the anchoring hole of the stationary base and for anchoring the supporting arm on the stationary base.

The supporting arm includes a chamber formed in the bottom portion of the supporting arm and opened forwardly. The supporting arm includes a spring blade received and engaged in the chamber of the supporting arm and extendible out of the chamber of the supporting arm.

The spring blade includes a projection extended forwardly therefrom and extendible out of the chamber of the supporting arm, the supporting arm includes a cover detachably attached to the bottom portion of the supporting arm for enclosing the chamber of the supporting arm, and the cover includes an opening for receiving and engaging with the projection of the spring blade and for allowing the projection of the spring blade to be extended out through the opening of the cover.

The supporting arm includes two or more channels formed in the upper portion and at a front portion of the supporting arm, and the carrier includes a bracket for slidably and adjustably engaging with the channels of the supporting arm. The fastener includes a head, and a knob attached to the head.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a stable support device in accordance with the present invention;

FIG. 2 is a front perspective view of the stable support device;

FIG. 3 is another front perspective view similar to FIG. 2, illustrating the operation of the stable support device;

FIG. 4 is a side plan schematic view of the stable support device; and

FIGS. 5 and 6 are side plan schematic views similar to FIG. 4, illustrating the operation of the stable support device.

### DETAILED DESCRIPTION OF THE PREFERRED EMBODIMENT

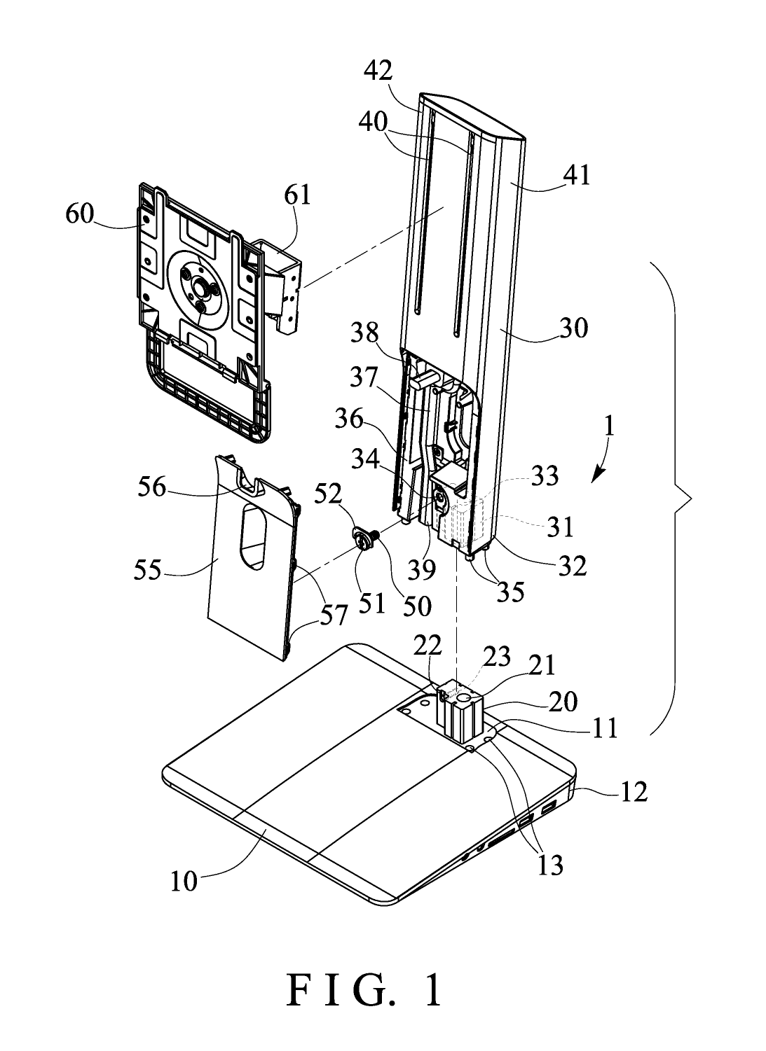

Referring to the drawings, and initially to FIGS. 1-4, a stable support device in accordance with the present invention comprises a stable supporting stand 1 including a stationary base 10 having a depression or recess 11 formed therein, such as formed in the rear portion 12 thereof, and including one or more (such as four) positioning or retaining or anchoring holes 13 formed therein and communicating with the recess 11 of the stationary base 10, and including an upright column or projection or post or protrusion 20 extended upwardly from the stationary base 10 and extended or located in the recess 11 of the stationary base 10, and the protrusion 20 includes a bore 21 longitudinally formed therein and faced or directed or opened upwardly, and includes a slot 22 formed therein and faced or directed or opened forwardly, and includes a screw hole 23 laterally formed therein and communicating with the slot 22 of the protrusion 20.

The supporting stand 1 further includes another post or protrusion or projection or upright column or supporting arm 30 having a chamber or compartment 31 formed therein, such as formed in the lower or bottom portion 32 thereof and opened downwardly for receiving or engaging with the protrusion 20 and for stably or solidly securing or anchoring or retaining or positioning or supporting the supporting arm 30 on the stationary base 10 at the perpendicular or tilted or inclined or upright position relative to the stationary base 10. The supporting arm 30 further includes a positioning or retaining or anchoring rod or post or pole 33 extended therefrom and extended into and located within the compartment 31 of the supporting arm 30 for engaging with the bore 21 of the protrusion 20 and for further stably or solidly securing or anchoring or retaining or positioning or supporting the supporting arm 30 on the stationary base 10. The bottom portion 32 of the supporting arm 30 includes an outer peripheral shape or structure or configuration or contour similar or identical to that of the recess 11 of the stationary base 10 for allowing the bottom portion 32 of the supporting arm 30 to be snugly fitted or engaged in the recess 11 of the stationary base 10.

The supporting arm 30 further includes an aperture or orifice 34 formed therein and communicating with the compartment 31 of the supporting arm 30, and aligned with the screw hole 23 of the protrusion 20 for slidably receiving or engaging with a screw or bolt or fastener 50 which is meshed or threaded or engaged with the screw hole 23 of the protrusion 20 for stably or solidly securing or anchoring or retaining or positioning the supporting arm 30 on the stationary base 10 and for preventing the supporting arm 30 from being disengaged or separated from the stationary base 10; and further includes one or more (such as four) positioning or retaining or anchoring pegs or keys or studs 35 extended downwardly therefrom for engaging with the anchoring holes 13 of the stationary base 10 and for further stably or solidly securing or anchoring or retaining or positioning or supporting the supporting arm 30 on the stationary base 10 and for preventing the supporting arm 30 from being oscillated or vibrated relative to the stationary base 10.

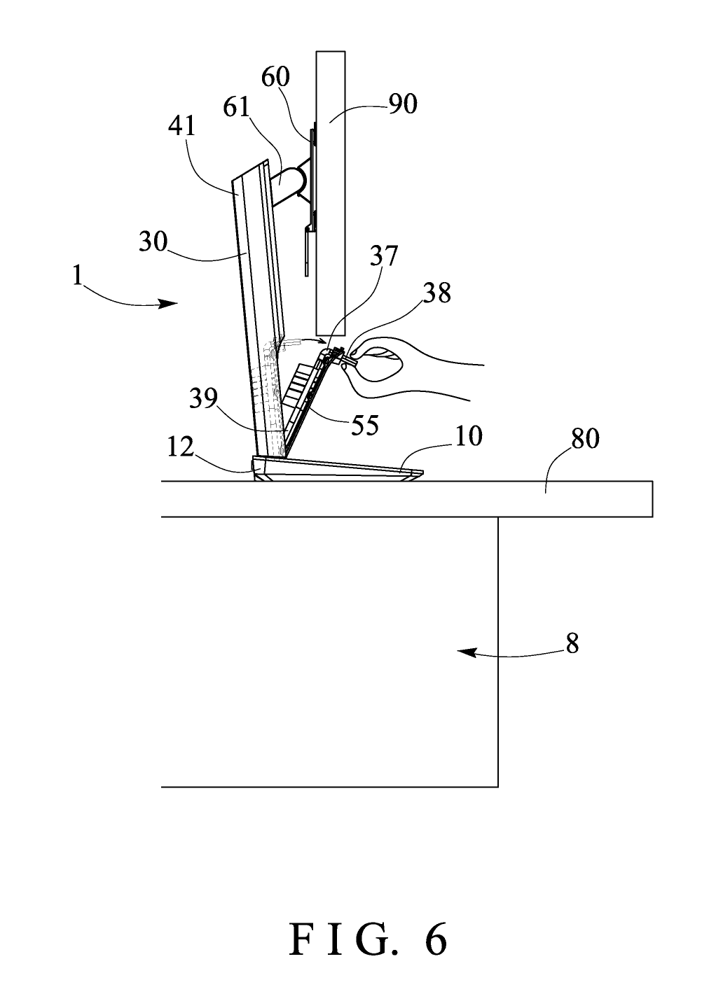

The fastener 50 includes an enlarged head 51, and a loop or wing or knob 52 pivotally or rotatably attached or mounted or secured to the head 51 for pivoting or rotating or driving the fastener 50 relative to the supporting arm 30 and the protrusion 20 and for suitably engaging the fastener 50 with the screw hole 23 of the protrusion 20 and for stably or solidly securing or anchoring or retaining or positioning the supporting arm 30 on the stationary base 10. The supporting arm 30 further includes a compartment or chamber 36 formed therein, such as formed in the lower or bottom portion 32 thereof and opened forwardly and offset from the compartment 31 of the supporting arm 30, and includes a spring member or blade 37 received or engaged in the chamber 36 of the supporting arm 30 and extendible or movable out of the chamber 36 of the supporting arm 30 (FIG. 6).

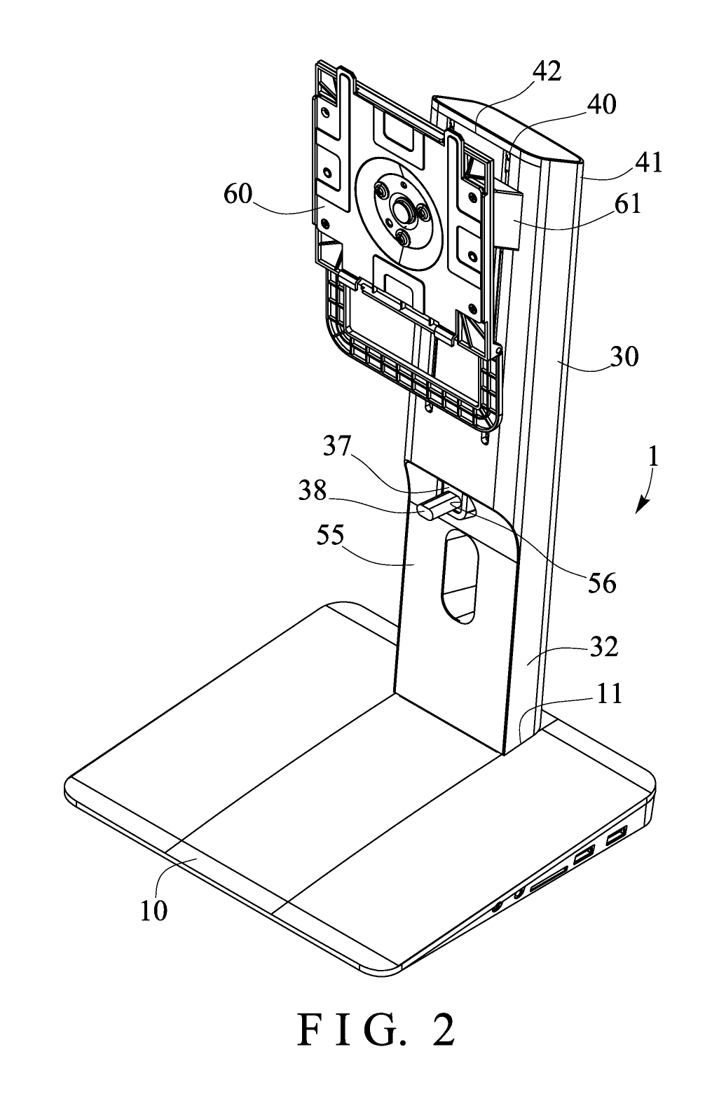

For example, the spring blade 37 includes a key or knob or projection 38 formed or provided on top thereof and extended forwardly therefrom and extended out of the chamber 36 of the supporting arm 30 for being pulled by the user in order to pull the spring blade 37 out of the chamber 36 of the supporting arm 30 (FIG. 6), and includes a lower or bottom portion 39 attached or mounted or secured to the supporting arm 30. The supporting arm 30 further includes a cap or cover 55 detachably or removably attached to the lower or bottom portion 32 of the supporting arm 30 for selectively blocking or enclosing the chamber 36 of the supporting arm 30, and the cover 55 includes a notch or opening 56 for slidably receiving or engaging with the projection 38 of the spring blade 37 and for allowing the projection 38 of the spring blade 37 to be extended out through the opening 56 of the cover 55 (FIG. 2, 3).

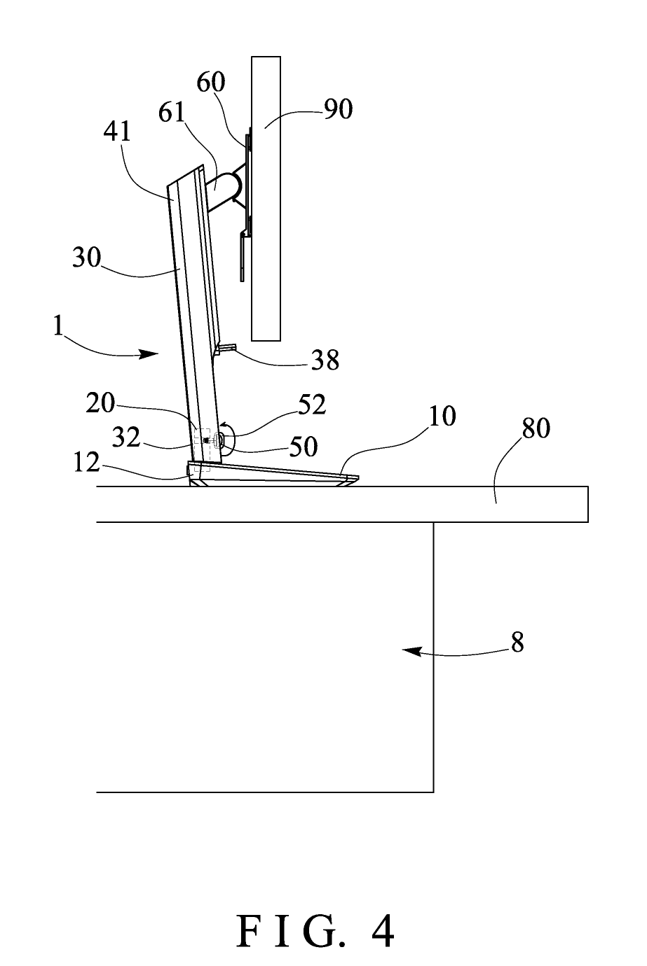

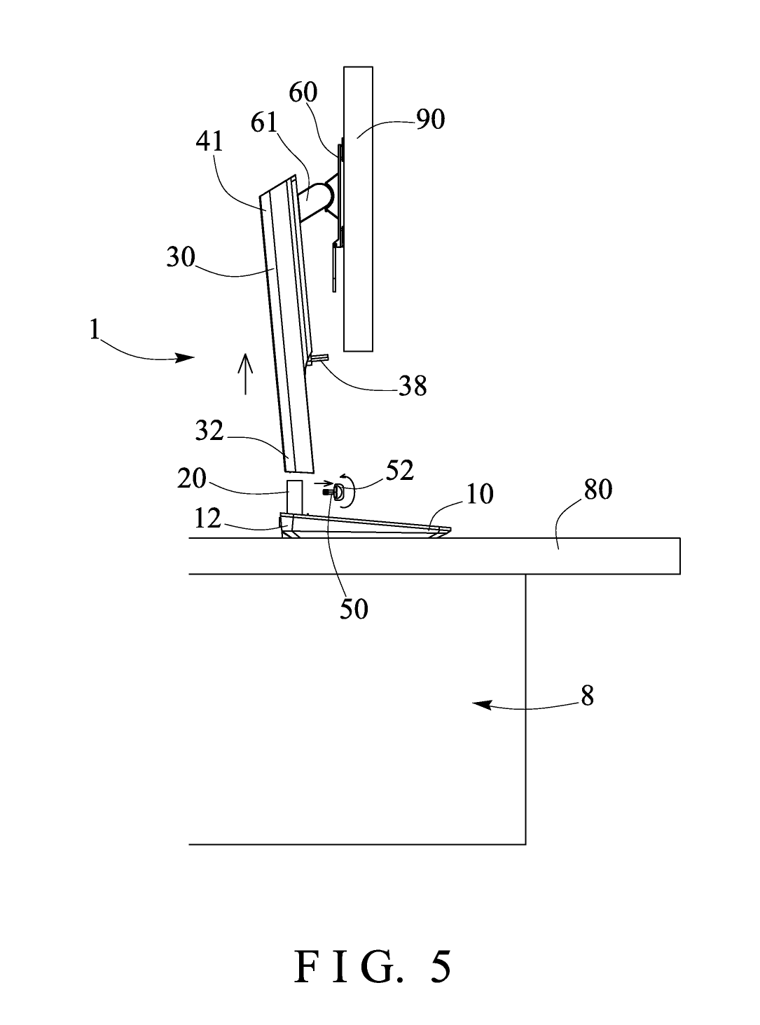

As shown in FIG. 1, the cover 55 may be detachably or removably attached to the lower or bottom portion 32 of the supporting arm 30 with tongues or catches or latches 57, and the cover 55 may be easily and quickly and readily detached or opened or disengaged or separated from the supporting arm 30 by pulling the projection 38 of the spring blade 37 outwardly or away from the supporting arm 30 (FIG. 6), and the fastener 50 may be easily and quickly and readily pivoted or driven or rotated relative to the supporting arm 30 and the protrusion 20 with the knob 52 in order to engage with or to be disengaged or detached or removed or separated from the supporting arm 30 and the protrusion 20 (FIGS. 4, 5) or so as to lock or unlock the supporting arm 30 to the protrusion 20 of the stationary base 10.

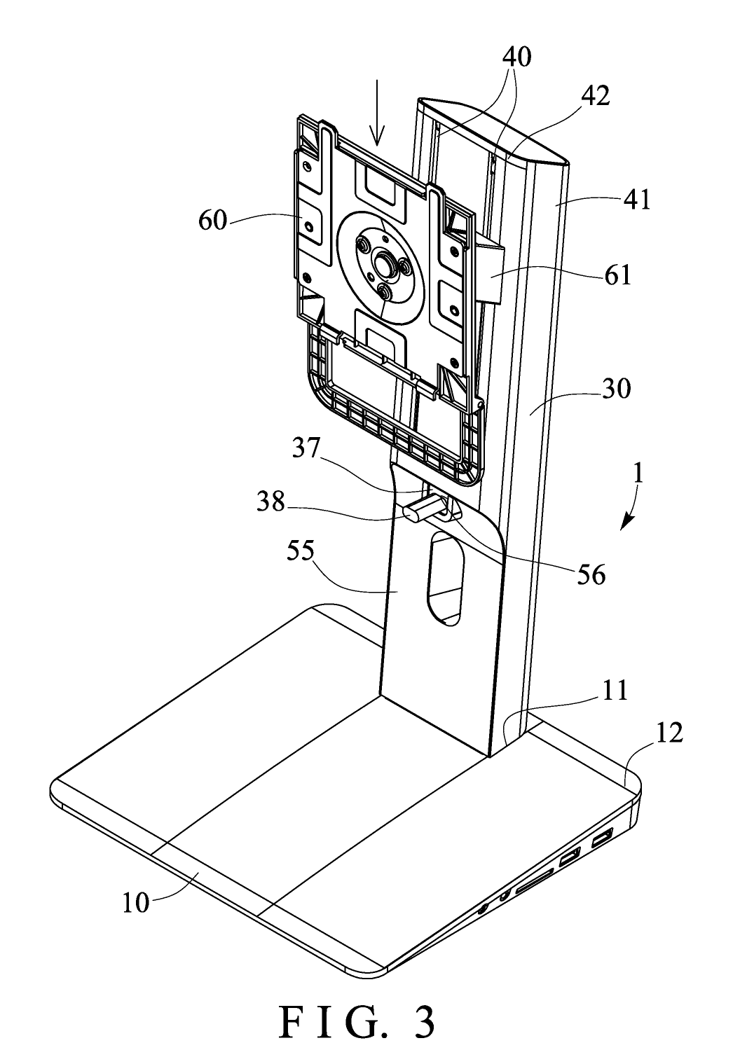

The supporting arm 30 further includes one or more (such as two) slots or grooves or track rails or channels 40 formed or provided in the upper portion 41 and at the front portion 42 thereof, the chamber 36 of the supporting arm 30 is formed or opened in the front portion 42 of the supporting arm 30, and a carrier 60 includes a bracket 61 slidably or adjustably engaged with the channels 40 of the supporting arm 30 (FIGS. 2, 3) for engaging with various objects 90 (FIGS. 4-6), such as monitors, displays, keyboards, antenna members, or the like and for detachably or removably or adjustably supporting the objects 90 on the supporting arm 30 and the stationary base 10. The above-described sliding attachment or engagement of the bracket 61 of the carrier 60 with the channels 40 of the supporting arm 30 is not related to the present invention and will not be described in further details.

In operation, as shown in FIGS. 1 and 4-6, the stationary base 10 may be provided or disposed or supported on a table plate 80 of a table 8 or the like, and the protrusion 20 of the stationary base 10 may then be engaged into the compartment 31 of the supporting arm 30, and the anchoring pole 33 of the supporting arm 30 may be engaged into the bore 21 of the protrusion 20, and the anchoring studs 35 of the supporting arm 30 may be engaged into the anchoring holes 13 of the stationary base 10 in order to stably or solidly secure or anchor or retain or position and support the supporting arm 30 on the stationary base 10 and for preventing the supporting arm 30 from being oscillated or vibrated relative to the stationary base 10, the fastener 50 may then be threaded or engaged with the screw hole 23 of the protrusion 20 for stably or solidly securing the supporting arm 30 on the stationary base 10 and for preventing the supporting arm 30 from being disengaged or separated from the stationary base 10.

The cover 55 may be detachably or removably attached to the lower or bottom portion 32 of the supporting arm 30 with tongues or catches or latches 57, and the cover 55 may be easily and quickly and readily detached or opened or disengaged or separated from the supporting arm 30 by pulling the projection 38 of the spring blade 37 outwardly or away from the supporting arm 30 (FIG. 6), it is to be noted that the fastener 50 may be easily and quickly and readily actuated or operated or pivoted or driven or rotated relative to the supporting arm 30 and the protrusion 20 with the knob 52, without additional driving tools, when the cover 55 is detached or disengaged or separated from the supporting arm 30.

Accordingly, the stable support device in accordance with the present invention includes a sliding structure or mechanism for coupling or attaching or mounting a carrier to a supporting stand and to support various objects, such as monitors, displays, keyboards, antenna members, or the like, and for providing a solid and stable supporting stand to solidly and stably support the carrier and the objects, such as the monitors, the displays, the keyboards, the antenna members, or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A support device comprising:
a stationary base including an upwardly extended protrusion, and including a screw hole formed in said protrusion,
a supporting arm including an upper portion and a bottom portion, and including a compartment formed in said bottom portion of said supporting arm and opened downwardly for engaging with said protrusion and for anchoring and supporting said supporting arm on said stationary base, and including an orifice formed in said supporting arm and communicating with said compartment of said supporting arm and aligned with said screw hole of said protrusion,
a carrier to be supported on said supporting arm, and
a fastener engaged through said orifice said supporting arm and engaged with said screw hole of said protrusion for securing said supporting arm on said stationary base and for preventing said supporting arm from being disengaged from said stationary base.

2. The stable support device as claimed in claim 1, wherein said protrusion of said stationary base includes a bore formed therein, and said supporting arm includes an anchoring pole extended into and located within said compartment of said supporting arm for engaging with said bore of said protrusion and for positioning said supporting arm on said stationary base.

3. The stable support device as claimed in claim 1, wherein said stationary base includes a recess formed therein for receiving and engaging with said bottom portion of said supporting arm.

4. The stable support device as claimed in claim 1, wherein said stationary base includes at least one anchoring hole formed therein, and said supporting arm includes at least one anchoring stud extended downwardly therefrom for engaging with said at least one anchoring hole of said stationary base and for anchoring said supporting arm on said stationary base.

5. The stable support device as claimed in claim 1, wherein said supporting arm includes a chamber formed in said bottom portion of said supporting arm and opened forwardly.

6. The stable support device as claimed in claim 5, wherein said supporting arm includes a spring blade received and engaged in said chamber of said supporting arm and extendible out of said chamber of said supporting arm.

7. The stable support device as claimed in claim 6, wherein said spring blade includes a projection extended forwardly therefrom and extendible out of said chamber of said supporting arm, said supporting arm includes a cover detachably attached to said bottom portion of said supporting arm for enclosing said chamber of said supporting arm, and said cover includes an opening for receiving and engaging with said projection of said spring blade and for allowing said projection of said spring blade to be extended out through said opening of said cover.

8. The stable support device as claimed in claim 1, wherein said supporting arm includes two channels formed in said upper portion and at a front portion of said supporting arm, and said carrier includes a bracket for engaging with said channels of said supporting arm.

9. The stable support device as claimed in claim 1, wherein said fastener includes a head, and a knob attached to said head.
